(19) United States
(12) Patent Application Publication
(10) Pub. No.: US 2026/0280974 A1
(43) Pub. Date: Sep. 17, 2026

(54) Electronic Control Device, Control System, and Control Method

(71) Applicant: Astemo, Ltd., Chiyoda-ku, Tokyo (JP)

(72) Inventors: Soshi SHIMOMURA, Tokyo (JP); Yutaka UEMATSU, Tokyo (JP); Masahiro TOYAMA, Tokyo (JP); Kimio NISHINO, Ibaraki (JP)

(21) Appl. No.: 19/162,978

(22) PCT Filed: Mar. 26, 2024
(86) PCT No.: PCT/JP2024/011943

§ 371 Date: Sep. 8, 2025

(30) Foreign Application Priority Data
Jun. 1, 2023 (JP) 2023-090834

(51) Int. Cl. H04L 41/069; H04L 41/0681

(52) U.S. Cl. CPC H04L 41/069; H04L 41/0681

(57) ABSTRACT

An electronic control device that t communicates with another device includes: a reading control unit that outputs a reading signal of log information to the another device at a predetermined timing; a determination unit that determines processing of the log information according to a processing load that changes in accordance with a control interval; and a saving unit that saves the log information in a memory, in which the determination unit determines not to save the log information in the memory in a case where the processing load of the electronic control device is higher than a predetermined threshold.

### INCORPORATION BY REFERENCE

This application claims priority to Japanese Patent Application No. 2023-90834 filed on Jun. 1, 2023, the contents of which are incorporated herein by reference.

### TECHNICAL FIELD

The present invention relates to an electronic control device that collects a log and a control method for collecting a log of a control system.

### BACKGROUND ART

To accommodate the recent advancements in information systems, networks in the systems have become increasingly sophisticated. For example, in communication between in-vehicle electronic control devices, hitherto, a single-function electronic control device (ECU) was locally connected and performed communication via bus communication such as controller area network (CAN). However, in recent years, a network has been formed across the entire in-vehicle system using Ethernet or the like, and a complicated network in which a plurality of electronic control devices are connected has been constructed.

With such complication of an in-vehicle network, occurrence of a communication failure has been increasing, and in particular, the frequency of occurrence of a non-reproducible communication failure has been increasing. Such a non-reproducible failure is difficult to analyze in terms of causes and requires a significant amount of effort to address. Therefore, it is necessary to take measures. In order to prepare for the cause analysis of the communication failure that may occur unpredictably at any time, it is necessary to collect a communication log during network operation and record an event that has occurred in the network when a problem occurs.

Various methods have been proposed for such a communication log collection method. For example, a transmission device described in PTL 1 (JP 2017-22470 A) includes: a plurality of signal processing units through which a main signal sequentially passes; a detection unit that acquires alarm information indicating the presence or absence of an alarm output from each of the plurality of signal processing units in every certain first period and detects a change in the alarm information; a time measurement unit that measures a time; a recording unit that acquires the time from the time measurement unit and records the alarm information in association with time information indicating the time when the change in the alarm information is detected by the detection unit; and a collection unit that collects the alarm information and the time information recorded by the recording unit in every second period longer than the certain first period.

### SUMMARY OF INVENTION

### Technical Problem

As described above, the processing performance required for a processor has increased with the multi-functionalization and advancement of the in-vehicle system. However, it is difficult to mount a high-performance processor in embedded equipment such as the in-vehicle electronic control device due to cost constraints, and a processing load of the processor at the time of periodic system logging becomes a problem.

PTL 1 proposes a method in which communication parameters are acquired and temporarily saved at short intervals, and a processor reads and saves data at longer intervals, thereby reducing the frequency of reading by the processor and reducing the processing load. However, when a time zone during which the normal processing load of the system is high overlaps with a log data processing time, the processing load of the processor may further increase.

An object of the present invention is to change a log collection method according to a load of a processor and collect a log without increasing a peak processing load of the processor.

### Solution to Problem

A representative example of the invention disclosed in the present application is as follows. That is, an electronic control device that communicates with another device includes: a reading control unit that outputs a reading signal of log information to the another device at a predetermined timing; a determination unit that determines processing of the log information according to a processing load that changes in accordance with a control interval; and a saving unit that saves the log information in a memory, in which the determination unit determines not to save the log information in the memory in a case where the processing load of the electronic control device is higher than a predetermined threshold.

### Advantageous Effects of Invention

According to an aspect of the present invention, it is possible to collect a log without increasing a peak processing load of a processor. Problems, configurations, and effects other than those described above will become apparent by the following description of embodiments.

### BRIEF DESCRIPTION OF DRAWINGS

FIG. 1 is a configuration diagram of a control system according to a first embodiment.

FIG. 2 is a diagram illustrating a configuration of data saved in a storage unit according to the first embodiment.

FIG. 3 is a configuration diagram of a control system according to a second embodiment.

FIG. 4 is a diagram illustrating a time-series change in a processing load of a processor according to a related art.

FIG. 5 is a diagram illustrating information regarding received data received by a communication system according to the second embodiment.

FIG. 6 is a sequence diagram illustrating a timing at which data is read from a buffer according to the second embodiment.

FIG. 7 is a diagram illustrating a time-series change in a processing load of a processor according to the second embodiment.

FIG. 8 is a configuration diagram of a control system according to a third embodiment.

FIG. 9 is a diagram illustrating a time-series change in a processing load of a processor according to the third embodiment.

FIG. 10 is a configuration diagram of a control system according to a fourth embodiment.

FIG. 11 is a configuration diagram of a control system according to a fifth embodiment.

FIG. 12 is a diagram illustrating an example of received data information in each operation mode according to the fifth embodiment.

FIG. 13 is a configuration diagram of a control system according to a sixth embodiment.

### DESCRIPTION OF EMBODIMENTS

Hereinafter, embodiments of the present invention will be described with reference to the drawings. The following description and drawings are examples for describing the present invention, and omission and simplification are appropriately made for clarity of description. The present invention can be carried out in various other forms. Unless otherwise specified, each component may be singular or plural.

The position, size, shape, range, and the like of each component illustrated in the drawings do not represent the actual position, size, shape, range, and the like in some cases in order to facilitate understanding of the invention. Therefore, the present invention is not necessarily limited to the position, size, shape, range, and the like disclosed in the drawings.

In the embodiments of the present invention, focusing on the fact that a processing load of a processor varies in accordance with a control interval of the entire system, processing of log data is adaptively changed according to the processing load. In the case of an information system such as a personal computer, the processing load of the processor dynamically varies depending on an application being executed or an action of a user, and it is difficult to predict the processing load. However, in an embedded system targeted by the embodiments of the present invention, data is periodically transmitted and received in accordance with the control interval of the system, and thus, the processing load of the processor periodically varies. As a result, since the processing load of the processor changes periodically, and processing of log information is changed in a time zone in which log collection is performed in accordance with such an interval and the processing load of the processor is high. In the embodiments of the present invention, a communication log and a system log can be collected without increasing a peak processing load of the processor by using such a control method. In addition, since the log collection can be implemented by a function of a general processor without adopting a high-performance chip for log collection, the logs can be collected at low cost.

In the following embodiments, an in-vehicle control system including a control device 1 and a communication device 2 will be described as an example, but the present invention can be applied to other general information equipment fields.

### First Embodiment

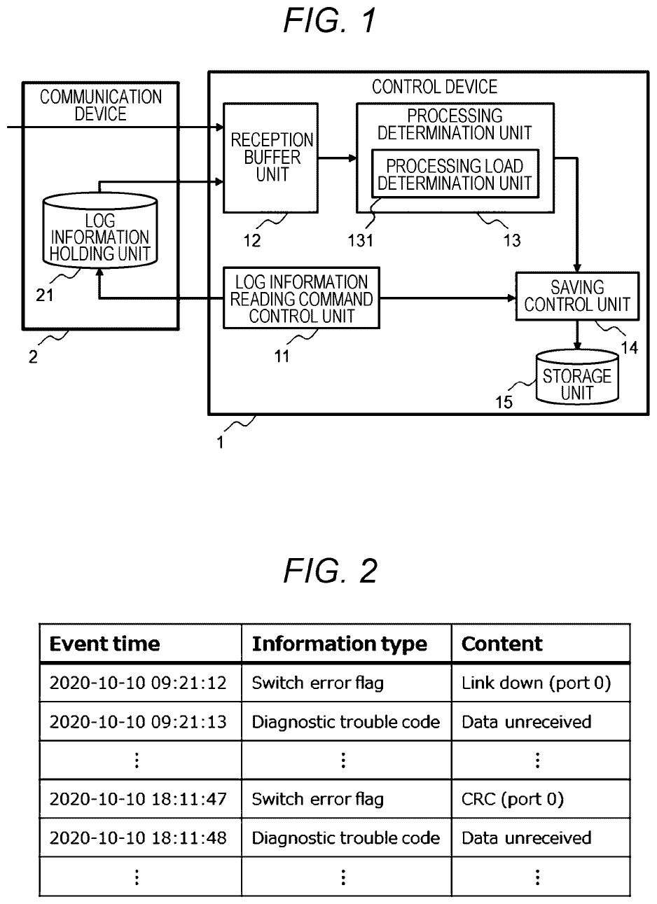

Hereinafter, a control system according to a first embodiment of the present invention will be described with reference to FIGS. 1 and 2.

FIG. 1 is a configuration diagram of the control system according to the first embodiment. A control device 1 and a communication device 2 are communicably connected to each other and transmit and receive data (for example, sensor data and control data for vehicle control) necessary for the main purpose of the system and log data.

The control device 1 is a control device including, for example, a processor and a memory, and includes a log information reading command control unit 11, a reception buffer unit 12, a processing determination unit 13, a saving control unit 14, and a storage unit 15. The communication device 2 is, for example, network equipment, and includes a log information holding unit 21. In FIG. 1, the control device 1 includes a processing determination unit 13 and a processing load determination unit 131, but the processing determination unit 13 and the processing load determination unit 131 may be provided in either the control device 1 or the communication device 2.

The log information reading command control unit 11 transmits a reading signal for reading data to the log information holding unit 21. The log information holding unit 21 transmits log information to the reception buffer unit 12 as a response to the received reading signal. The reception buffer unit 12 temporarily stores the data necessary for the main purpose of the system and the log data. The log information is a status register value of the communication device 2 and data provided by an integrated circuit (IC). The data provided by the IC is, for example, a log imaging frame saved inside a camera in order for the camera to diagnose a state of a lens of the camera and a state of an image processing circuit in an in-vehicle system.

Next, the processing load determination unit 131 predicts or monitors a processing load of the processor of the control device 1. The processing determination unit 13 determines a log data processing method according to the current processing load of the processor. For example, an operation of reading the log information from the reception buffer unit 12 is temporarily suspended during a period in which the current processing load of the processor is larger than a predetermined threshold. The processed log data is transmitted to the saving control unit 14. The saving control unit 14 adds a timestamp to a log content and writes the log content with the timestamp in the storage unit 15. The timestamp may indicate a time at which the log information is read or an occurrence time of an event related to a corresponding log. At this time, the saving control unit 14 may calculate the timestamp based on the number of times of transmission of the reading signal by the log information reading command control unit 11. For example, in a case where the log information reading command control unit 11 transmits the reading signal at predetermined time intervals, the timestamp can be generated based on a reference time and the number of times of transmission of the reading signal. In addition, the number of times of transmission of the reading signal may be used as the timestamp indicating a relative time.

The storage unit 15 is implemented by a volatile storage device and a nonvolatile storage device. FIG. 2 is a diagram illustrating a configuration of the data saved in the storage unit 15. As illustrated in FIG. 2, the storage unit 15 saves one or more records including an event occurrence time, an event type, and an event content. The event occurrence time is a time at which the log information is read from the log information holding unit 21. As the event type, a diagnostic trouble code (DTC) of a vehicle may be used in an in-vehicle electronic control device. The event content is a content of a trouble indicated by the log information. The storage unit 15 saves the log data in the volatile storage device such as a dynamic random access memory (DRAM) during system operation. The storage unit 15 may write the data stored in the volatile storage device into the nonvolatile storage device such as a hard disk drive (HDD) upon termination of system operation. In a case where the system is a connected system connectable to the Internet, the log data may be saved in the volatile storage device during system operation and transmitted to an external storage such as a data center upon system termination.

A specific log data processing method in the first embodiment will be described in detail in second and subsequent embodiments.

### Second Embodiment

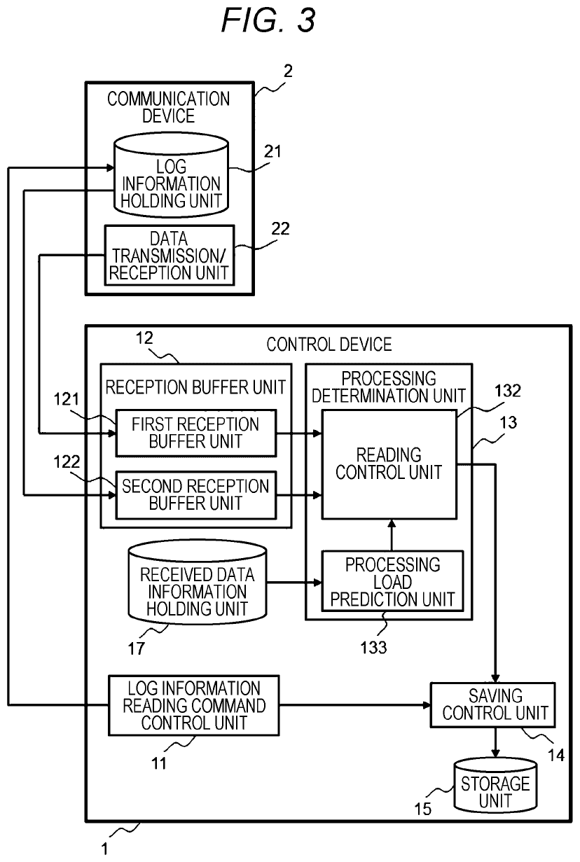

Hereinafter, a control system according to a second embodiment of the present invention will be described with reference to FIGS. 3 to 7.

In the following description, differences from the first embodiment will be mainly described. The same components as those in the first embodiment are denoted by the same reference numerals, and points not specifically described are the same as those in the first embodiment. The second embodiment is different from the first embodiment in including a reading control unit 132 that reads data of a reception buffer.

FIG. 3 is a configuration diagram of the control system according to the second embodiment. A control device 1 and a communication device 2 are communicably connected to each other and transmit and receive data (for example, sensor data and control data for vehicle control) necessary for the main purpose of the system and log data.

The control device 1 is a control device including, for example, a processor and a memory, and includes a log information reading command control unit 11, a reception buffer unit 12, a processing determination unit 13, a saving control unit 14, a storage unit 15, a sequence adding unit 16, and a received data information holding unit 17. The reception buffer unit 12 includes a first reception buffer unit 121 that temporarily stores data necessary for the main purpose of the system and a second reception buffer unit 122 that temporarily stores log data. The processing determination unit 13 includes a reading control unit 132 and a processing load prediction unit 133. The communication device 2 is, for example, network equipment, and includes a log information holding unit unit 21 and a data transmission/reception unit 22. The processing determination unit 13 is provided in the control device 1. However, the processing determination unit 13 may also be provided in the communication device 2.

The sequence adding unit 16 adds sequence information to the received log data and saves the data in the second reception buffer unit 122 for the log data. The received data information holding unit 17 transmits, to the processing load prediction unit 133, information regarding a data reception interval of the control device 1 determined in advance at a design stage, a data amount, and the like. The processing load prediction unit 133 predicts a period during which the processing load peaks based on the information, and transmits a prediction result to the reading control unit 132. The reading control unit 132 temporarily a reading operation from the second reception buffer unit 122 during a period in which the processing load is larger than a predetermined threshold.

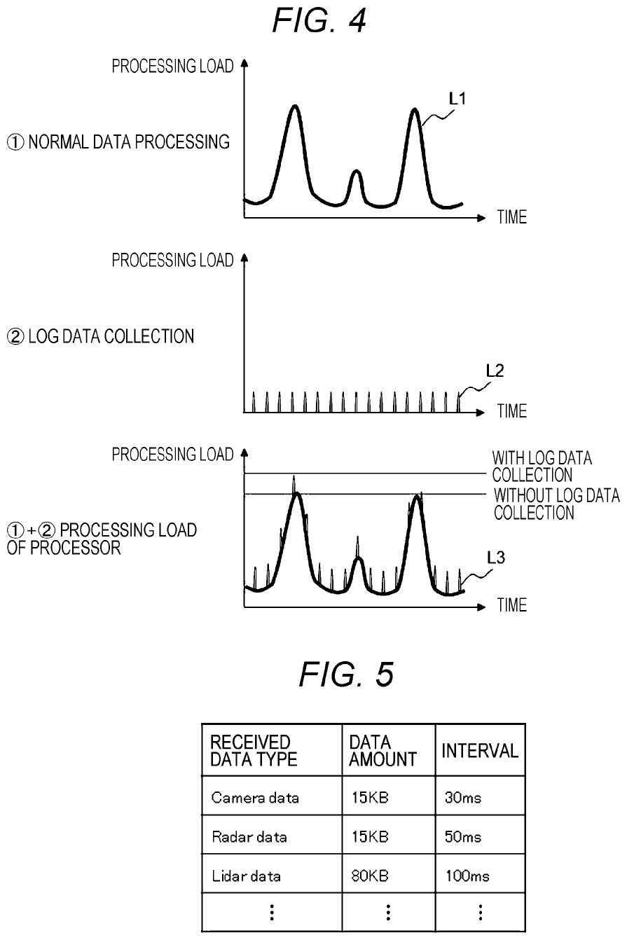

FIG. 4 is a diagram illustrating a time-series change in a processing load of a processor according to a related art, and illustrates a processing load L1 of the processor for data processing necessary for the main purpose of the system, a processing load L2 of the processor for data processing of log data, and L3 (L1+L2) which is a final processing load of the processor. In particular, in an embedded system, data necessary for system operation is periodically transmitted and received in accordance with a control interval of the system, and as a result, the processing load periodically increases and decreases like L1.

Next, a specific example of a prediction method of the processing load prediction unit 133 will be described.

FIG. 5 is a diagram illustrating information regarding received data received by a communication system. For example, in an automated driving system, the control device 1 receives camera data obtained by imaging the outside world by a camera, radar data obtained by observing the outside world by a radar, and lidar data including a point cloud obtained by observing the outside world by LiDAR. In this example, it is predicted that a processing load peak occurs every 300 ms that is the least common multiple of reception intervals of respective pieces of data, and such prediction information is delivered to the reading control unit 132.

Next, a specific example of a reading control method of the reading control unit 132 and effects thereof will be described.

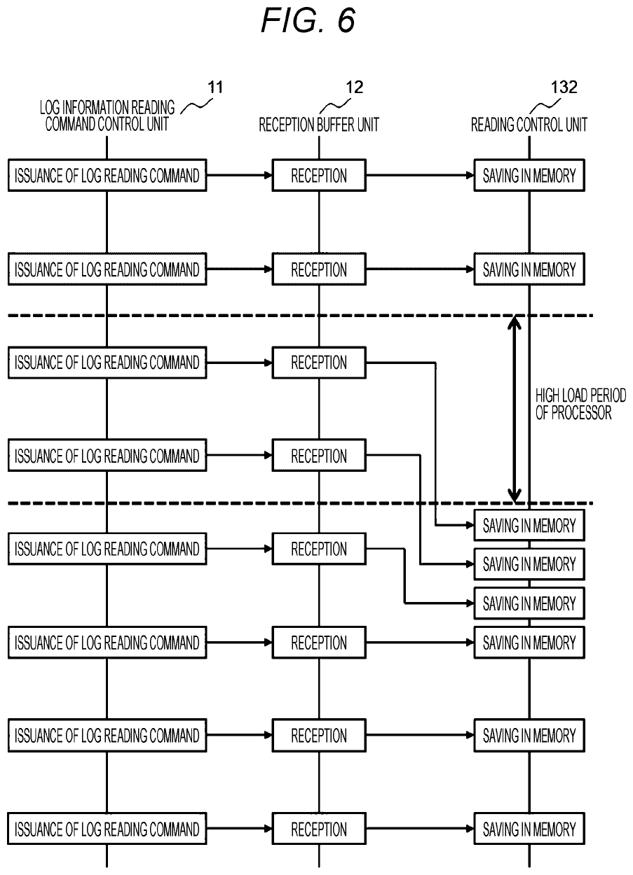

FIG. 6 is a sequence diagram illustrating a timing at which the data is read from the buffer, and illustrates operations of the log information reading command control unit 11, the second reception buffer unit 122, and the reading control unit 132.

The log information reading command control unit 11 transmits a log reading command at a predetermined timing (for example, a predetermined time interval), and the second reception buffer unit 122 receives the log data at the timing. In general reading control, the data is read from the reception buffer by a strict priority (SP) method, a round robin (RR) method, or a reading method obtained by combining these methods. In the present embodiment, temporary suspension control for data reading according to the processing load peak described above is performed. For example, control is performed to temporarily suspend data reading from the reception buffer unit 12 for 5 ms before and after the above-described processing load peak that occurs every 300 ms. As a result, the log data is stored in the second reception buffer unit 122 during a period in which the processor has a high load. When the period of the temporary suspension control for data reading ends, the reading control unit 132 starts processing of reading the data stored in the second reception buffer unit 122.

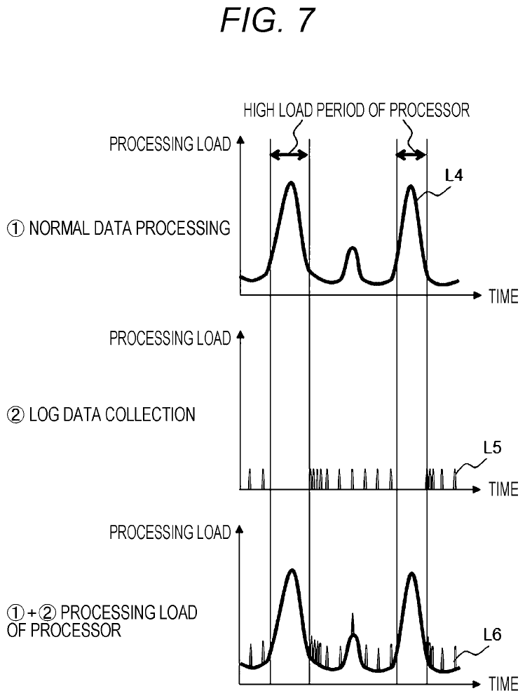

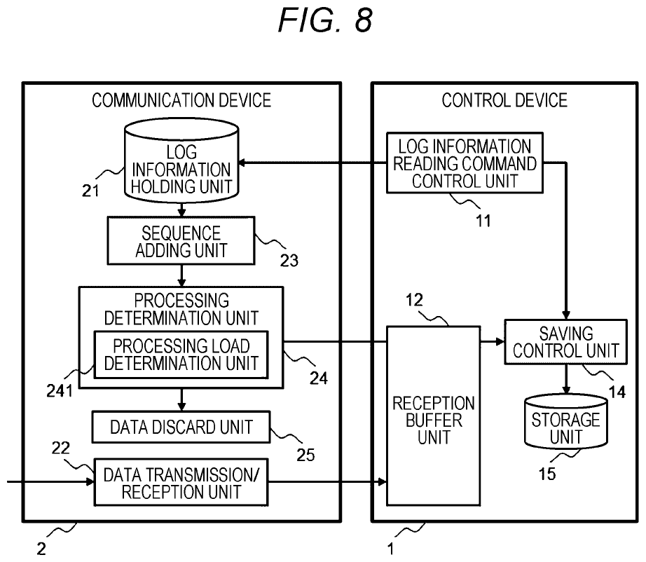

FIG. 7 is a diagram illustrating a time-series change in the processing load of the processor according to the second embodiment, and illustrates a processing load L4 of the processor for data processing necessary for the main purpose of the system, a processing load L5 of the processor for data processing of the log data, and a final processing load L6 (L4+L5) of the processor. By the processing of suspending the processing of the data stored in the second reception buffer unit 122 described above, the load does not increase in a high-load period of the processor, and the maximum value of the final processing load L6 of the processor can be reduced.

### Third Embodiment

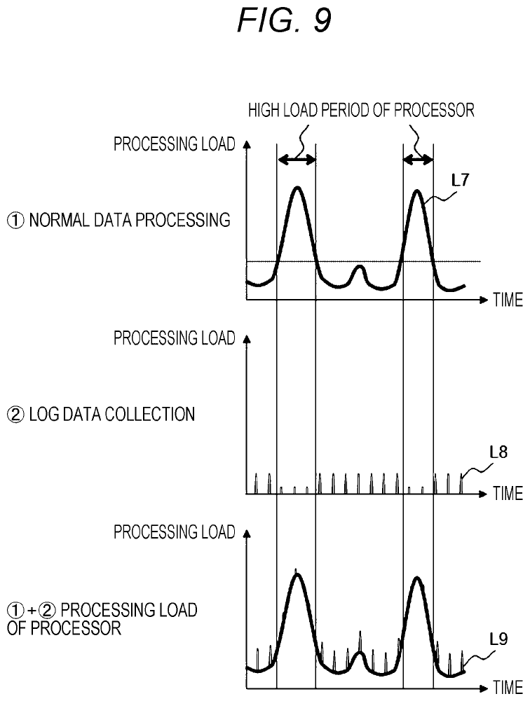

Hereinafter, a control system according to a third embodiment of the present invention will be described with reference to FIGS. 8 and 9.

In the following description, differences from the first embodiment will be mainly described. The same components as those in the first embodiment are denoted by the same reference numerals, and points not specifically described are the same as those in the first embodiment. The third embodiment is different from the first embodiment in that a data discard unit is included.

FIG. 8 is a configuration diagram of the control system according to the third embodiment. A control device 1 and a communication device 2 are communicably connected to each other and transmit and receive data (for example, sensor data and control data for vehicle control) necessary for the main purpose of the system and log data.

The control device 1 is a control device including, for example, a processor and a memory, and includes a log information reading command control unit 11, a reception buffer unit 12, a saving control unit 14, and a storage unit 15. The communication device 2 is, for example, network equipment, and includes a log information holding unit 21, a data transmission/reception unit 22, a sequence adding unit 23, a processing determination unit 24, and a data discard unit 25. The processing determination unit 24 includes a processing load determination unit 241 that determines whether or not to transmit log data based on current processing load information.

The log information reading command control unit 11 transmits a log reading command at a predetermined timing (for example, a predetermined time interval).

The log information holding unit 21 transmits the log data to the sequence adding unit 23 at the timing. The sequence adding unit 23 adds sequence information to the log data and transmits the log data to the processing determination unit 24. The processing determination unit 24 determines whether or not to transmit the log data based on the current processing load information determined by the processing load determination unit 241. In a case where it is determined not to transmit the log data, the processing determination unit 24 transmits the log data to the data discard unit 25. The data discard unit 25 discards the received log data. On the other hand, in a case where it is determined to transmit the log data, the processing determination unit 24 transmits the log data to the control device 1.

Next, a specific processing load determination method of the processing load determination unit 241 will be described.

An object of the present invention is to reduce a processing load of the processor of the control device 1, and the processing load determination unit 241 determines the processing load of the control device 1. Therefore, the processing load determination unit 241 acquires real-time processing load information from the control device 1 or acquires use amount information of a transmission buffer to determine the processing load of the control device 1. This is effective particularly in a case where Ethernet communication is adopted. The Ethernet communication relies heavily on software for a communication function, and in a case where the Ethernet communication is adopted in embedded equipment, Ethernet communication processing may occupy a significant portion of the processing load of the processor. Therefore, in a case where the communication device 2 is an Ethernet switch or the like, a timing of an increase or decrease in use amount of the transmission buffer of the communication device 2 and a timing of an increase or decrease in processing load of the control device 1 substantially coincide with each other.

Next, a specific example of a processing control method of the processing determination unit 24 and effects thereof will be described.

The processing determination unit 24 stops transmission of some or all of the pieces of log data in a periodic processing load peak period and discards the pieces of log data. As a simple control example, there is a control method in which while the processing load determination unit 241 sets a high load flag register, the processing determination unit 24 transfers all the pieces of log data to the data discard unit 25 and discards the pieces of log data. As a result, the log data is not transferred to the control device 1 in a high load period. Further, there is a control method in which while the processing load determination unit 241 sets the high load flag register, the processing determination unit 24 leaves log data to which an error flag is attached in the log information holding unit 21, and transfers log data to which the error flag is not attached to the data discard unit 25 and discards the log data. As a result, the number of pieces of log data transferred to the control device 1 in the high load period is reduced. At this time, when time series information of the log data is lost due to discarding of the data, the sequence adding unit 23 adds the sequence information in order to confirm a correct order of the log.

FIG. 9 is a diagram illustrating a time-series change in the processing load of the processor according to the third embodiment, and illustrates a processing load L7 of the processor for data processing necessary for the main purpose of the system, a processing load L8 of the processor for data processing of the log data, and L9 (L7+L8) which is a final processing load of the processor. By processing of reducing an amount of the transmitted log data described above, the load of the processor in the high load period can be reduced, and the final processing load L9 of the processor can be reduced.

### Fourth Embodiment

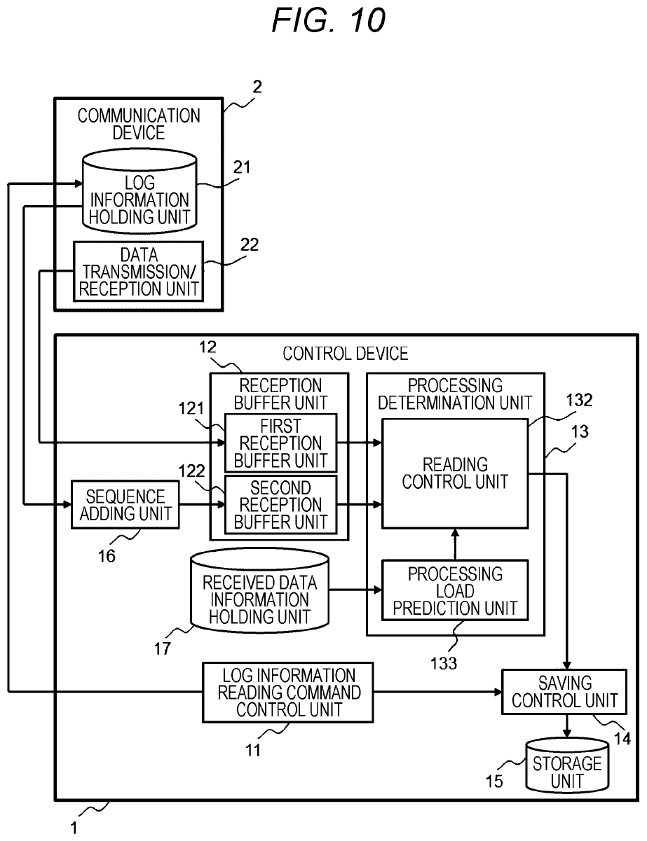

Hereinafter, a control system according to a fourth embodiment of the present invention will be described with reference to FIG. 10.

In the following description, differences from the first embodiment will be mainly described. The same components as those in the first embodiment are denoted by the same reference numerals, and points not specifically described are the same as those in the first or second embodiment. The fourth embodiment is different from the first embodiment in that a sequence adding unit that adds sequence information to log information is provided.

FIG. 10 is a configuration diagram of the control system according to the fourth embodiment. A control device 1 and a communication device 2 are communicably connected to each other and transmit and receive data (for example, sensor data and control data for vehicle control) necessary for the main purpose of the system and log data.

The control device 1 is a control device including, for example, a processor and a memory, and includes a log information reading command control unit 11, a reception buffer unit 12, a processing determination unit 13, a saving control unit 14, a storage unit 15, a sequence adding unit 16, and a received data information holding unit 17. The reception buffer unit 12 includes a first reception buffer unit 121 that temporarily stores data necessary for the main purpose of the system and a second reception buffer unit 122 that temporarily stores log data. The processing determination unit 13 includes a reading control unit 132 and a processing load prediction unit 133. The communication device 2 is, for example, network equipment, and includes a log information holding unit 21 and a data transmission/reception unit 22. The processing determination unit 13 is provided in the control device 1. However, the processing determination unit 13 may also be provided in the communication device 2.

The sequence adding unit 16 is provided between the log information holding unit 21 and the reception buffer unit 12. The sequence adding unit 16 is provided in the control device 1. However, The sequence adding unit 16 may also be provided in the communication device 2. The sequence adding unit 16 adds the sequence information counted up according to the number of times of transmission of a reading signal by the log information reading command control unit 11 to the log information and transmits the log information to the reception buffer unit 12.

According to the fourth embodiment, the following functions and effects can be obtained. Even in a case where a time at which the log data is read is changed or the log data is discarded, the processing determination unit 13 can obtain an accurate time at which the log data is acquired by using the sequence information. For example, in a case where the log information reading command control unit 11 transmits the reading signal at an interval of 10 ms and the sequence information is 2000, the saving control unit 14 can determine that the log information is log information acquired 20 seconds after the start of system operation regardless of the presence or absence of a preceding or subsequent signal and a reception time. Therefore, a timestamp for the log data can be accurately saved.

### Fifth Embodiment

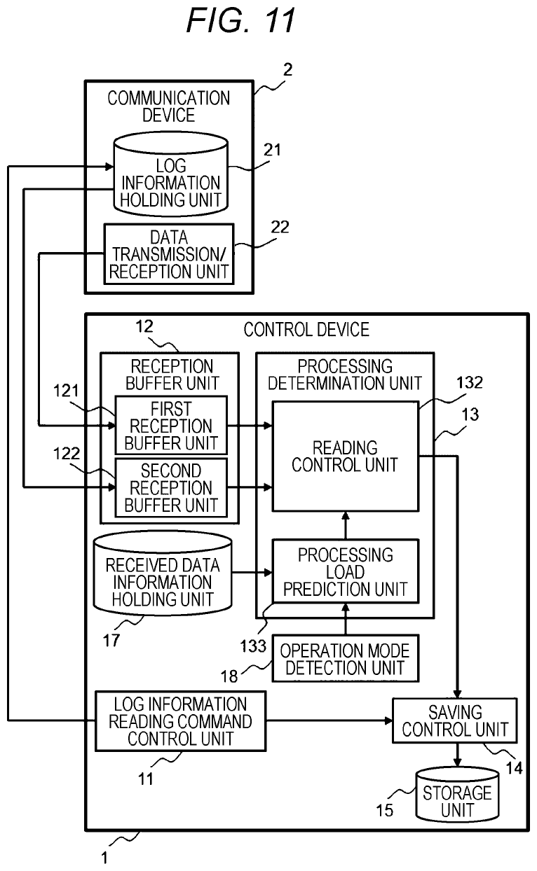

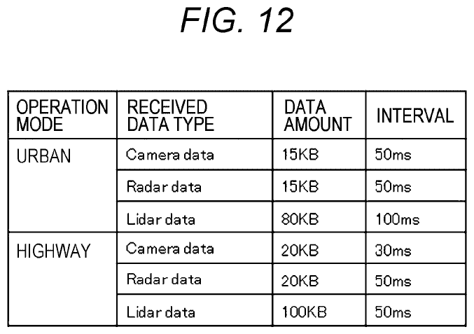

Hereinafter, a control system according to a fifth embodiment of the present invention will be described with reference to FIGS. 11 and 12.

In the following description, differences from the first embodiment will be mainly described. The same components as those in the first embodiment are denoted by the same reference numerals, and points not specifically described are the same as those in the first or second embodiment. The fifth embodiment is different from the first embodiment in that an operation mode detection unit 18 that detects an operation mode of the control device 1 is provided.

FIG. 11 is a configuration diagram of the control system according to the fifth embodiment. A control device 1 and a communication device 2 are communicably connected to each other and transmit and receive data (for example, sensor data and control data for vehicle control) necessary for the main purpose of the system and log data.

The control device 1 is a control device including, for example, a processor and a memory, and includes a log information reading command control unit 11, a reception buffer unit 12, a processing determination unit 13, a saving control unit 14, a storage unit 15, a received data information holding unit 17, and the operation mode detection unit 18. The reception buffer unit 12 includes a first reception buffer unit 121 that temporarily stores data necessary for the main purpose of the system and a second reception buffer unit 122 that temporarily stores log data. The processing determination unit 13 includes a reading control unit 132 and a processing load prediction unit 133. The communication device 2 is, for example, network equipment, and includes a log information holding unit 21 and a data transmission/reception unit 22. The processing determination unit 13 is provided in the control device 1. However, the processing determination unit 13 may also be provided in the communication device 2.

The operation mode detection unit 18 determines the operation mode of the control device 1 and transmits current operation mode information to the processing load prediction unit 133. The processing load prediction unit 133 recalculates a peak period of a processing load according to the operation mode. For example, it is assumed that there are an urban driving mode, a highway mode, an automatic parking mode, and the like in an in-vehicle system, and an amount and an interval of data received by the control device 1 are changed depending on the operation mode. The received data information holding unit 17 holds information regarding the received data changed depending on the operation mode. FIG. 12 is a diagram illustrating an example of received data information in each operation mode, and the operation mode, a received data type, a data amount, and an interval are recorded.

According to the fifth embodiment, the following functions and effects can be obtained. Since the processing load prediction unit 133 recalculates the peak period of the processing load according to the operation mode, for example, in the example illustrated in FIG. 12, when mode switching from an urban traveling mode to a highway traveling mode is made, a processing load peak interval is changed from 100 ms to 150 ms. Therefore, even in a system having a plurality of operation modes, it is possible to accurately predict a period in which the processing load peaks.

### Sixth Embodiment

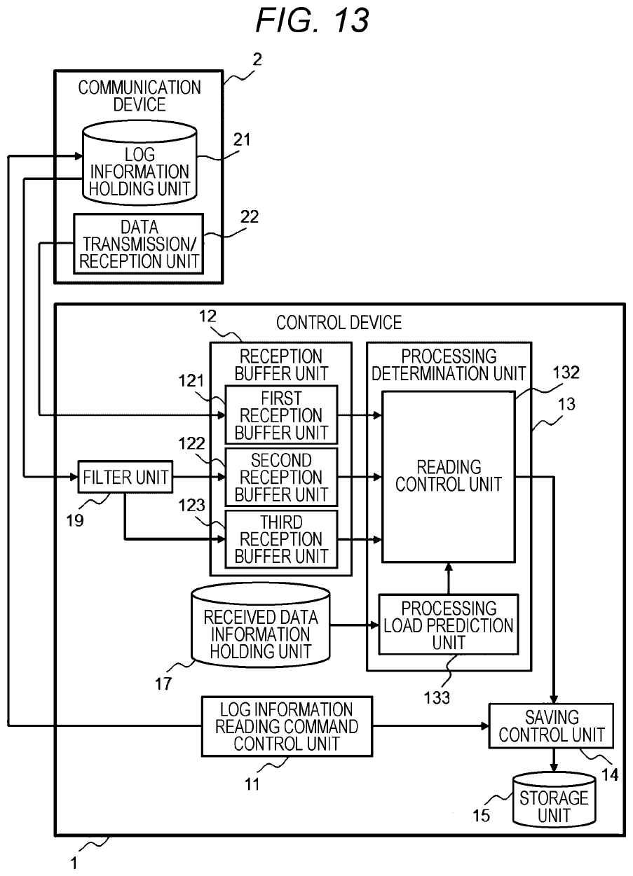

Hereinafter, a control system according to a sixth embodiment of the present invention will be described with reference to FIG. 13.

In the following description, differences from the first embodiment will be mainly described. The same components as those in the first embodiment are denoted by the same reference numerals, and points not specifically described are the same as those in the first or second embodiment. The sixth embodiment is different from the first embodiment in that a filter unit 19 that selects a buffer for storing a log is provided.

FIG. 13 is a configuration diagram of the control system according to the sixth embodiment. A control device 1 and a communication device 2 are communicably connected to each other and transmit and receive data (for example, sensor data and control data for vehicle control) necessary for the main purpose of the system and log data.

Log information stored in a log information holding unit 21 includes information regarding a type of a log (that is, a position of a register in which the log information is stored). The filter unit 19 selects the buffer for storing the log based on a content of the received log. For example, an operation of classifying the logs into a log that requires immediate response and a log that does not require immediate response is performed. Reading control performed by a processing determination unit 13 is applied to the log that does not require immediate response.

According to the sixth embodiment, the following functions and effects can be obtained. The filter unit 19 selects a log that needs to be handled by the system as soon as possible, and a reading control unit 132 reads the selected log as soon as possible. Therefore, it is possible to reduce latency of the log that requires immediate response, such as information regarding safety, and to safely control a vehicle.

Note that the present invention is not limited to the above-described embodiments and includes various modified examples and equivalent configurations within the scope of the appended claims. For example, the above-described embodiments have been described in detail in order to explain the present invention in an easy-to-understand manner, and the present invention is not necessarily limited to those having all the configurations described. Further, a part of the configuration of one embodiment may be replaced with the configuration of another embodiment. In addition, the configuration of one embodiment may be added to the configuration of another embodiment. In addition, a part of the configuration of each embodiment may be added with another configuration, may be deleted, and may be replaced with another configuration.

Further, a part of, or the entirety of the respective configurations, functions, processing units, processing means, and the like described above may be implemented by hardware, for example, may be designed as an integrated circuit, or may be implemented by software for a processor interpreting and executing programs for implementing the respective functions.

Information such as a program, a table, and a file for implementing each function can be stored in a storage device such as a memory, a hard disk, or a solid state drive (SSD), or a recording medium such as an integrated circuit (IC) card, a secure digital (SD) card, or a digital versatile disc (DVD).

In addition, the control lines and information lines indicate those considered necessary for explanation, and do not necessarily indicate all the control lines and information lines necessary for implementation. In actual implementation, it may be considered that almost all the configurations are interconnected.

1. An electronic control device that communicates with another device, the electronic control device comprising:
a reading control unit that outputs a reading signal of log information to the another device at a predetermined timing;
a determination unit that determines processing of the log information according to a processing load that changes in accordance with a control interval; and
a saving unit that saves the log information in a memory,
wherein the determination unit determines not to save the log information in the memory in a case where the processing load of the electronic control device is higher than a predetermined threshold.

2. The electronic control device according to claim 1, comprising:
a reception buffer unit that temporarily stores the received log information;
an information holding unit that holds received data information regarding data received by the electronic control device;
a processing load prediction unit that predicts the processing load of the electronic control device based on the received data information; and
a reading control unit that controls a timing of reading the log information from the reception buffer unit according to the predicted processing load.

3. The electronic control device according to claim 1, comprising a sequence adding unit that adds sequence information to the log information.

4. The electronic control device according to claim 1, comprising:
an information holding unit that holds received data information regarding data received by the electronic control device for each operation mode of the electronic control device;
a processing load prediction unit that predicts the processing load of the electronic control device based on the received data information; and
an operation mode detection unit that detects a change in the operation mode,
wherein the processing load prediction unit predicts the processing load of the electronic control device based on the received data information for each operation mode.

5. The electronic control device according to claim 1, comprising a filter unit that selects the log information to determine a buffer for storing the log information.

6. A control system comprising:
an electronic control device;
a communication device that communicates with the electronic control device; and
a determination unit that determines processing of log information according to a processing load of the electronic control device that changes in accordance with a control interval,
wherein the communication device includes a log information saving unit that saves the log information,
the electronic control device includes:
a reading control unit that outputs a reading signal of the log information to the communication device at a predetermined timing; and
a saving unit that saves the log information in a memory, and
the determination unit determines not to save the log information in the memory in a case where the processing load of the electronic control device is higher than a predetermined threshold.

7. The control system according to claim 6, wherein
the communication device includes the determination unit, and
the communication device includes a data discarding unit that discards some or all of pieces of the log information when the processing load of the electronic control device is high.

8. A control method for log information in a control system including a reading control unit that outputs a reading signal of the log information, a determination unit that determines processing of the log information according to a processing load that changes in accordance with a control interval, and a saving unit that saves the log information in a memory,
the control method comprising:
outputting, by the reading control unit, the reading signal of the log information to the another device at a predetermined timing; and
determining, by the determination unit, not to save the log information in the memory in a case where the processing load of the electronic control device is higher than a predetermined threshold.
